(19) United States
(12) Patent Application Publication
(10) Pub. No.: US 2013/0043302 A1
(43) Pub. Date: Feb. 21, 2013

(54) SOCIAL MEDIA PLATFORMS

(71) Applicants: Mark Stuart Powlen, San Francisco, CA (US); Michael Brandon Ferrel, San Jose, CA (US)

(72) Inventors: Mark Stuart Powlen, San Francisco, CA (US); Michael Brandon Ferrel, San Jose, CA (US)

(21) Appl. No.: 13/588,368

(22) Filed: Aug. 17, 2012

Related U.S. Application Data
(60) Provisional application No. 61/525,085, filed on Aug. 18, 2011.

(51) Int. Cl. G06F 17/30; G06K 19/06

(52) U.S. Cl. 235/375; 235/494

(57) ABSTRACT

Provided are methods and systems using quick response (QR) codes for facilitating social interactions using social media. The QR codes may be generated by a service provider upon request from a user and forwarded to this and/or other users. The QR codes may encode specific user information, such as user contact information, or may encode a webpage URL for directing users to a website. The website may be hosted by the service provider and contain information for a particular event, such as a guest list and currently present attendees, or information about a group. Upon receiving a QR code from the provider, a user may choose to print this code or to display it on a mobile device. The user may scan the QR code at the venue location to gain access. Other invitees associated with this event may receive notification of the user now being present at the venue.

### CROSS-REFERENCE TO RELATED APPLICATIONS

This application claims the benefit of U.S. Provisional Patent Application No. 61/525,085, filed on Aug. 18, 2011, which is incorporated herein by reference in its entirety for all purposes.

### FIELD

The present disclosure relates generally to data processing. More particularly, the present disclosure relates to methods and systems of facilitating social interaction using social media.

### BACKGROUND

Quick Response (QR) codes have been used in the past for tracking automobile parts in manufacturing. However, these codes are still in the early stages of adaptation by other businesses despite their capabilities for storing substantial amounts of information, in comparison for example to a linear barcode. A QR code is a specific type of a data matrix barcode, which is also referred to as two-dimensional code or a data matrix code. The QR code is typically readable by specially designed QR readers. The QR code may include black or color modules arranged in special patterns on a white background. The pattern of these modules defines information encoded in the barcode. The information encoded in the QR code can be made of four standardized kinds of data (i.e., numeric, alphanumeric, byte/binary, and Kanji), or more, through supported extensions. Generally, the amount and type of data provided in a barcode depends on the barcode size.

### SUMMARY

Provided are methods and systems using quick response (QR) codes for facilitating social interaction using social media. The QR codes may be generated by a service provider upon request from a user and may be forwarded to this and/or other users. The QR codes may encode specific user information, such as user contact information, or may encode a Uniform Resource Locator (URL) for directing users to a website. The website may be hosted by the service provider and contain information for a particular event, such as a guest list and currently present attendees. Upon receiving a QR code from the provider, a user may choose to print this code or to display it on a mobile device. The user may scan the QR code at the venue location to gain access. Other invitees associated with this event may receive notification of the user now being present at the venue.

Provided is a method for facilitating social interaction using social media. The method may include providing an application management console for collecting information associated with an event and receiving the information associated with an event. The information associated with the event may include a contact list, venue information, and/or update to the rules. For example, a user may provide a list or group of invitees, address and description of the venue, set up payment, set up rules for updating invitees based on various events, such as new people added, people actually present at the venue, and the like. The method may also involve generating one or more QR codes corresponding to the information associated with an event. Each QR code encodes a dataset, which may include personal contact information (e.g., name, phones, email address of the person) and/or webpage URL. The webpage URL may be used to direct a user, who retrieved the dataset to a particular website, selected by another user. For example, a social media website (e.g., a Facebook page), business website, or a special website with information about the venue may be used. Some of these websites may be hosted by the service provider and automatically generated together with the corresponding QR codes. The QR codes or corresponding datasets may then be transmitted to various users. Once a dataset is transmitted, the dataset may be then converted into a QR code on a user device using an application provided by the service provider. QR codes may be transmitted as image files without the need for a special application. For example, a QR code may be transmitted as one or more images file and may be enclosed as a part of an e-mail.

Once the QR code or the dataset (later encoded into the QR code) is transmitted to a user or, more specifically, to a client device controlled by the user, it may be converted into a physical form (e.g., printed as a label and become part of the clothing) or it may be displayed on the user interface of the client device and scanned by another device right from the interface. The scanning device may be a specifically configured QR code scanner or a device capable of capturing an image of the barcode. The captured image may be decoded right at the device or transmitted to the service provider for decoding. The dataset retrieved from the QR code may be used directly (e.g., name and contact information) or to obtain further information (e.g., a dataset is a webpage URL).

In some embodiments, the method may include receiving the dataset encoded by the QR code from a client device and transmitting at least some of the information associated with the event to the client device. For example, the client device may retrieve a webpage URL encoded by the QR code. This URL may then be used by the client device to access a webpage hosted by the service provider to obtain additional information (e.g., venue location). In some embodiments, the information transmitted to the client device in response to receiving the data set includes a webpage URL (e.g., to another site such as social network), a contact profile, or a text. The contact profile includes one or more of a contact photo, a contact name, a contact address, a contact phone number, a contact e-mail address, or a text.

In some embodiments, the received dataset encoded by the QR code may be used to update the information associated with the event at the service provider. For example, scanning the QR code may be interpreted as checking into a particular venue. In other words, a user who provided his QR code for scanning may be listed as a person who is present at the venue. This information may be used to update the list of people that are currently at the venue and, in some embodiments, update other users on new people checking into the venue. The received dataset encoded by the QR code may include specific user identification information. For example, custom QR codes may be issued to different users. In other embodiments, this user identification information is provided in addition to the QR code, and the QR code may be the same for all users. As noted above, the updated information associated with the event may be provided to one or more client devices identified in the updated information. In some embodiments, the method may also involve generating a new QR code corresponding to the updated information associated with the event and transmitting the new QR code or the new dataset encoded by the new QR code to one or more client devices identified in the updated information.

When a dataset is transmitted to a user, a user device may be used to generate a QR code for future uses. In a similar manner, when a user device scans a QR code, it may be capable of extracting a dataset encoded in the QR code. Specifically, the user device may include an application for encoding QR codes and/or decoding QR codes. When an application is not present, a user device may request a download of the application from the service provider. Furthermore, the service provider may determine that a user device needs an application prior to transmitting a dataset to the device. In these situations, the method involves transmitting an application to a client device for decoding the QR code.

In some embodiments, the application management console used for collecting information associated with an event is also operable to simulate a graphical user interface of a client device after scanning the QR code. For example, once the information is provided through the application management console, the user may test how this information will be presented to other users once their QR codes are scanned. As noted above, the information may be presented in the form of a website hosted by the service provider or other forms, e.g., a locally presented dataset.

In some embodiments, the method may involve transmitting descriptor information associated with the QR code. The descriptor information may be displayed together with the QR code, e.g., on a user interface of the client device. The descriptor information may include text and/or images relevant to the dataset encoded in the QR code.

Provided also is a social media platform including an application management console for collecting information associated with an event, a database for storing the information associated with the event, a Quick Response (QR) code generator for generating a QR code corresponding to the information associated with an event, and an application engine for transmitting the QR code or a dataset encoded by the QR code and receiving the dataset. Provided also is a machine readable medium having embodied thereon executable code. The executable code being executed by a processor for performing various operations for facilitating social media and event planning listed above.

In further embodiments, modules, subsystems, or devices can be adapted to perform the recited methods. Furthermore, in various embodiments, a machine readable medium may have executable code embodied thereon, with the executable code being executable by a processor for performing above methods.

### BRIEF DESCRIPTION OF FIGURES

FIG. 1 is a block diagram of an environment in which various embodiments directed to a social media platform may be practiced.

FIG. 2 is a flowchart of an example method for facilitating social interaction using social media, in accordance with certain embodiments.

FIG. 3 is a block diagram of example QR codes which can be accessed by an automated sensing device and capable of being turned into a text and/or other visual data.

FIGS. 4-10 illustrate various examples of user interfaces provided by the application management console, in accordance with some embodiments.

FIG. 11 illustrates an example of a QR code displayed together with the descriptor information, in accordance with some embodiments.

FIG. 12 is a core functionality diagram, according to an example embodiment.

FIG. 13 is an event functionality diagram, according to an example embodiment.

FIG. 14 shows a diagrammatic representation of a computing device for a machine in the example electronic form of a computer system, within which a set of instructions for causing the machine to perform any one or more of the methodologies discussed herein can be executed.

FIGS. 15-23 illustrate various examples of user interfaces provided by the client application, in accordance with some embodiments.

### DETAILED DESCRIPTION

QR codes or, more generally, two dimensional codes or data-matrices may be used to store a substantial amount of information in comparison, for example, to linear barcodes. The encoded information may be referred to as a dataset. The dataset may include various alphanumeric characters. The data capacity of the QR codes may depend on the quality of the code produced on one end and quality of code scanner on the other end and the size of the codes. Typically, the codes are provided on a physical media, for example, printed on paper. However, these codes may be produced on a graphical user interface of a computer system and scanned directly from that interface. Furthermore, scanning may be performed using specially configured scanners or by capturing images of the codes and analyzing these images using special software provided on the image capturing device or another device communicatively coupled to the image capturing devices.

Smart phones and other portable computer systems provide new opportunities for utilizing information exchange using QR and other types of codes. Several key features of the smart phones, such as graphical interface, image capturing, on board processing, and data transfer, allow for developing and implementing new methods and systems for facilitating social interaction using social media and QR codes. For example, the graphical interface may be used to present QR codes without the need for any physical representation of these codes. As such, various dynamically generated codes may be presented on the same device. Image capturing functionality of the smart phones may allow using these devices to scan the codes and avoid using specialized scanners. The captured images may be analyzed by the device to present the encoded information on its user interface. Alternatively, the captured images may be transmitted to the service providers for further analysis and results of the analysis may be transmitted back to the device. Communication capabilities of smart phones allow updating the information associated with QR codes and distributing this information to the same and /or other phones. Overall, this functionality may become valuable for facilitating social interaction using social media as described above.

The device level functionalities described above may be coupled with various back-end services implemented, for example, on a server of a service provider. These back-end services may be used, for example, to provide an application management console for collecting information associated with an event. The application management console may be presented to one or more user to set up an event, update provided information (e.g., guest lists, contact information, venue information). The back-end services may then generate one or more QR codes that are transmitted to the client devices, e.g., smart phones. These QR codes may be used as venue passes, sources of contact and other information, and for other purposes. The application management console may be used to set various rules associated with a scan of a QR code. For example, a scan may be used to update a list of the people already present at the venue, to indicate that two or more people exchange their contact information, retrieve a particular website, and for other purposes.

In some embodiments, a dataset encoded by a QR code may include a webpage Uniform Resource Locator (URL). This URL may direct a client device that scanned this QR code to a website not associated with the service provider (e.g., any website selected by a user) or a website specifically created by the service provider for a particular venue. Sometimes, URLs may contain too many characters for users to easily share these URLs in a dictate-type mode. QR codes may provide unique opportunities to transmit these URLs from one device to another. Furthermore, accessing a website created by the service provider may trigger certain rules, such as updating a list of attendees and others.

Overall, QR codes may be used to encode a text string addressed to a particular user, to encode contact information for adding a vCard contact to the user's device, to encode a Uniform Resource Locator (URL) to direct a user to a website, to encode an entire e-mail or text message, or other things. Using methods and systems described herein, users may generate and decode QR codes that encode social data by visiting a code generating website or service integrated into a website or by using a code generating application provided on a mobile device or a computer. Additionally, users may be able to print, copy/paste, or otherwise use pre-generated QR codes received via an electronic communication or downloaded from a website.

QR codes may be printed on physical items such as paper, stickers, temporary tattoos, packages, and so forth. Alternatively, QR codes may be displayed on displays of mobile phones or any other type of displays. Users with a camera phone equipped with a QR reader/decoding application may scan the image of the QR code to display or otherwise use a corresponding encoded text, contact information, and social network profile. The QR code may be used to connect to a wireless network, open a web page in the telephone's browser using the encoded URL, and perform various other functions using the mobile device. Various embodiments may be utilized to create a social event, aggregate social information, and create peer-to-peer exchanges. Some embodiments disclosed herein may allow utilizing QR codes to enable multiple social media functionalities. QR codes and associated encoded data may be integrated with social media functions and other social activities and stored in a database for future use.

Various embodiments may be used in a nightclub, party, and other social gatherings and environments to facilitate introductions to strangers. For example, a user may scan a QR code presented by a stranger to acquire quick access to his/her personal information, such as a bio, social network profile page, webpage, and picture, thereby receiving some initial personal information prior to a formal introduction. Thus, users may communicate, acquire, and share information through QR codes ahead of time. The scanned information may be added to a database and stored together with other previously scanned information. If a scanned QR code is associated with a user, the user may be informed that his or her information has been scanned. Users associated with scanned QR codes may be categorized/grouped and stored as contacts. Various events may be associated with various categories/groups of scanned contacts. Other information such as alerts created and events organized may also be associated with contacts or groups. Various uses may include a promotion, event, party, get-together, reunion, creation of a log of people present at an event, creation of activities around events and interests, and social event planning.

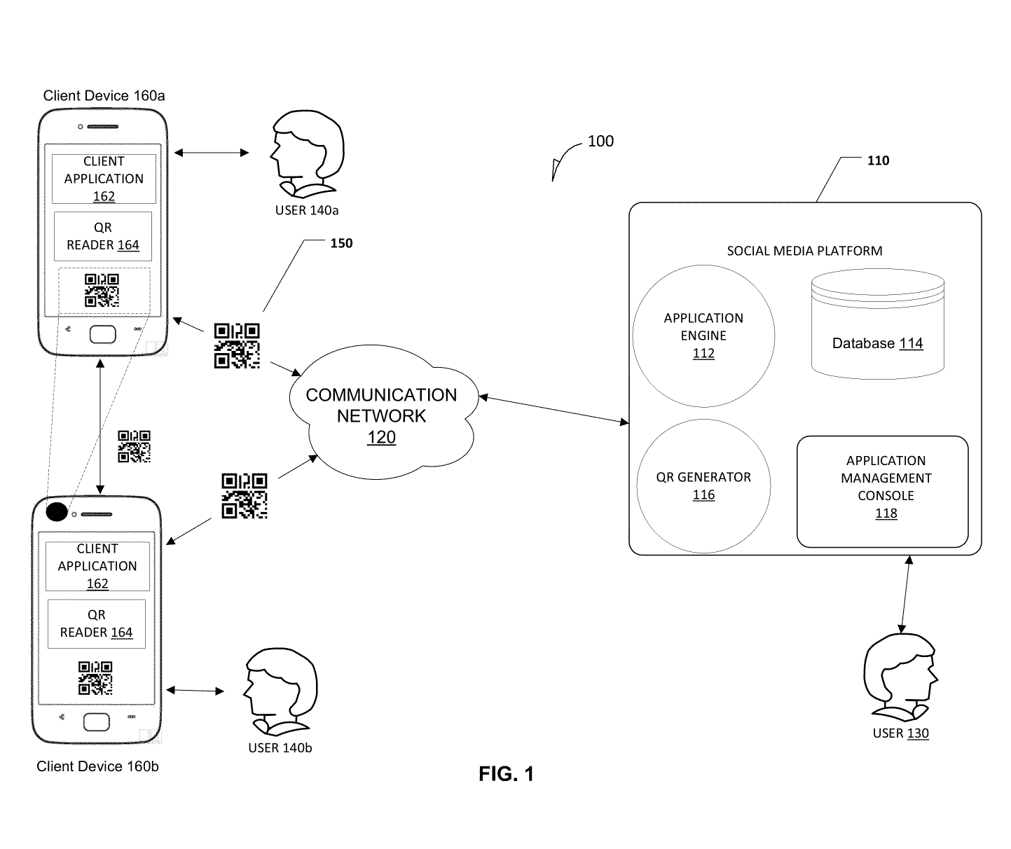

FIG. 1 is a block diagram of an environment 100 in which various embodiments directed to a social media platform 110 may be practiced. The environment 100 may include the social media platform 110 and multiple client devices 160a and 160b. The social media platform 110 and each of multiple client devices 160a and 160b may be coupled through a communication network 120. Communication between client devices 160a and 160b may be either through the communication network 120 or directly, e.g., by scanning a QR code presented on a graphical user interface of one client device with a scanner (e.g., camera) of another client device. FIG. 1 schematically illustrates the client device 160b scanning the QR code provided on the graphical user interface of the client device 160a. Client devices 160a and 160b are shown to be controlled by users 140a and 140b, while the social media platform 110 is being controlled by user 130. The user 130 may be referred to as an organizer in some embodiments further described below.

The social medial platform 110 may include an application engine 112, a database 114, a QR generator 116, and an application management console 118. The application management console 118 may be used for collecting information associated with an event. For example, the application management console 118 may provide an interface for the user 130 to enter information, such as guest lists, contact information of the user 130 and guests, venue location, rules associated with scans of QR codes, create groups, and the like. The application management console 118 may also allow the user 130 to view QR codes and actions associated with these codes, send these codes to selected users (e.g., the users 140a and 140b), simulate scans of the codes, assign and modify the rules associated with the codes, and complete other actions. The database 114 may be used for storing the information associated with the event, such as QR codes, contact information, and other information listed above. The QR code generator 116 is used for generating a QR code corresponding to the information associated with an event. The QR codes may be generated at least once, when the event is initially created. In some embodiments, new QR codes may be generated later in response to some actions of various users. The application engine 112 is used for transmitting the QR code or a dataset encoded by the QR code and receiving the dataset.

Each of the client devices 160a and 160b may include a client application 162 and a QR reader 164. The client application 162 may be part of the social media platform, in some embodiments, and may integrate the QR reader 164. Some examples of the client devices 160a and 160b include mobile phones (e.g., smart phones), tablet computers, laptop computers, and the like. In general, any computer system may be used as the client devices 160a and 160b. The client application 162 may include computer software designed to work with services provided by the social media platform 110. The client application 162 may be bundled with the client devices 160a and 160b (e.g., it may be transmitted by the social media platform upon the request from the client devices 160a and 160b) or it may be published separately and/or may be available for download from a website associated with the social media platform. The QR reader 164 may include any third party barcode scanners like, for example, ZXing or Kaywa that may be embedded or attached to the client devices 160a and 160b. In some embodiments, the QR reader 164 is software capable of analyzing an image captured by a scanning device (e.g., a camera) of a client device. The image includes a QR code and the QR reader 164 decodes the QR code and retrieves the encoded data set.

The communication network 120 may couple two or more network modules (e.g., the client device 160 and the social media platform 110) together to allow communication and transmitting of data between these modules. In some examples, the communication network 120 may be a public computer network, such as the Internet, or a private computer network, such as a wireless telecommunication network, wide area network (WAN), local area network (LAN), or various combinations thereof. In some embodiments, the communication network 120 comprises multiple routers, bridges, and hubs that couple a large number of digital devices.

An example method may start with the user 130 sending invitations to a group of people including the users 140a and 140b. The users 140a and 140b may receive the invitation and, based on the invitation, create a QR code 150 using a website associated with the social media platform 110. Alternatively, the user 130 may create QR codes for each user in the group of people using the social media platform 110 or, more specifically, the QR generator 116 of the social media platform. The user 130 may then send these QR codes via an electronic communication to the users 140a and 140b. The QR code 150, when decoded by the client application 162, may, for example, represent an admission ticket to an event. At the event, the QR code 150 may be scanned using the client device and processed by the client application 162. It should be noted that the QR code 150 may be presented on the graphical interface of one client device (e.g., the client device 160a in FIG. 1) and scanned by another client device (e.g., the client device 160b in FIG. 1). Alternatively, a user may present a physical representation of the QR code in a form of a label, for example. Upon scanning the QR code 150 at the event, certain predetermined actions may be performed. For example, an alert may be sent to everybody at the event to inform them who all are present.

In another example, some embodiments may enable playing various games, such as, for example, awarding prizes to a selected few people (e.g., the first 10 people who scanned their QR codes). The QR codes may be displayed on a mobile device or printed on various media or gear such as a t-shirt, sticker, temporary tattoo, or any other physical object.

If the user 130 utilizes the application management console 118 to create the QR code 150, he/she may program it with a specific occasion in mind. Later, the user 130 may utilize the same settings at a different event or reprogram the QR code 150 for a different occasion. Alternatively, the user 130 may create multiple QR codes for different events. For example, the user 130 may utilize one QR code for social events and another QR code for business events.

The user 130 may utilize the application management console 118 to modify the actions performable by the client application 162 when the QR code 150 is scanned on the fly. Depending on these settings, different information may be shown such as social network profiles, images, and so forth. In addition, users may receive alerts of events in their respective areas, for example, a tie-in of celebrities, upon scanning their QR codes, get special access to their fan sites, get access to a special nightclub by having the right QR code, and/or get a special promotion of a product. Various embodiments are not limited to social interactions, and may, as well, be used to organize any kind of meeting, demonstrate different places within a company and inquire whether any employees are checked in to those places, or to find a meeting.

In some example embodiments, instead of having a QR reader to process a QR code, Near Field Communication (NFC) technology may be utilized. The NFC technology may allow for reading a code with a touch between a mobile device associated with the user 140 and the client device 160 or positioning the two devices within the field of communication. The NFC technology does not require a direct line of sight for the client devices to exchange the information. Many mobile devices currently on the market already include embedded NFC chips that can send encrypted data a short distance (“near field”) to a reader located, for instance, next to a retail cash register. Besides reading the code, the NFC technology may allow making instant credit card payments or serve as a keycard or identification card. Using the NFC technology, a user may make purchases with tied-in payment systems using authenticated transactions.

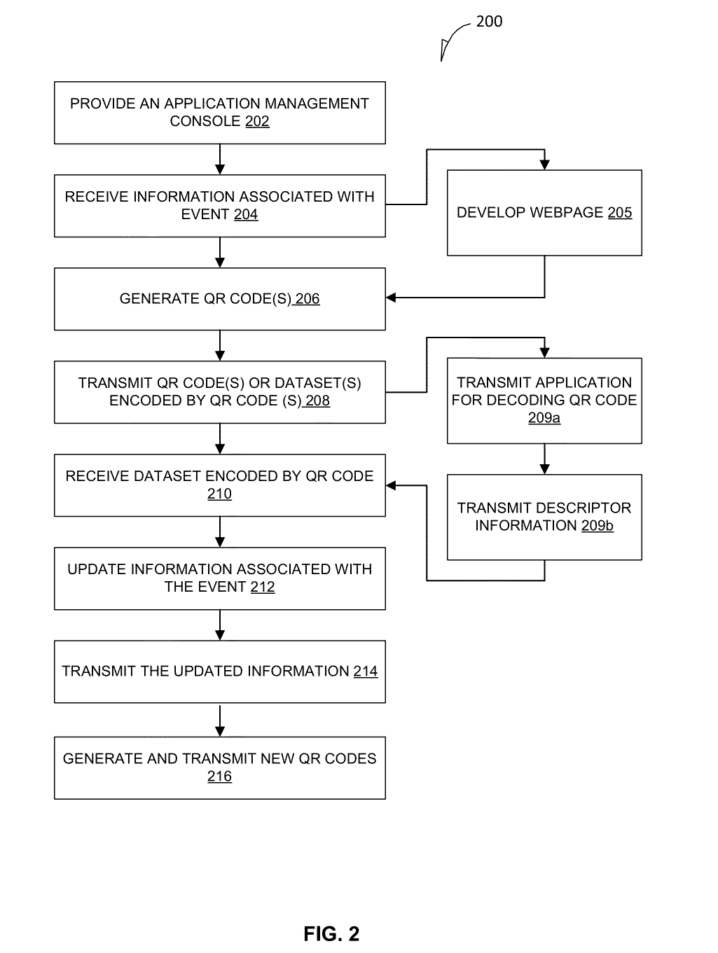

FIG. 2 is a flowchart of an example method using QR codes for facilitating social interaction using social media. The method 200 may be performed by processing logic that may include hardware (e.g., dedicated logic, programmable logic, microcode, etc.), software (such as run on a general-purpose computer system or a dedicated machine), or various combinations thereof. In one exemplary embodiment, the processing logic resides at the social media platform 110, as illustrated in FIG. 1.

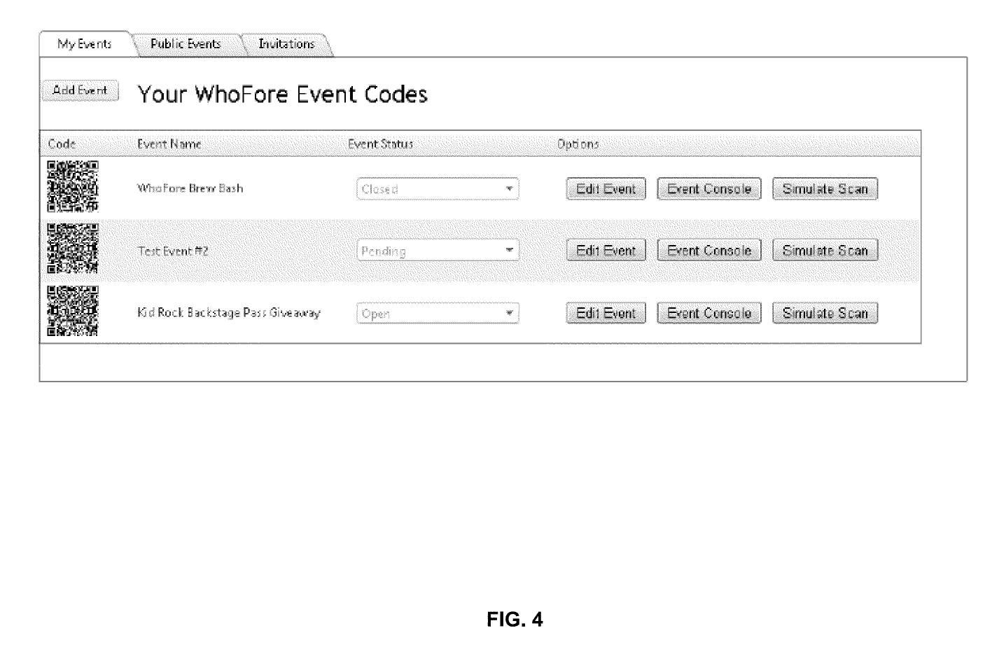

The method 200 may commence with providing an application management console during operation 202. As described above, the application management console is used for collecting information associated with an event. Examples of user interfaces corresponding to the application management console are presented in FIGS. 4-10. Specifically, FIG. 4 illustrates an interface listing multiple codes, associated description, and options. As shown in FIGS. 4-9, some of the codes encode websites, some encode texts, and still other ones encode profiles. When a website encoding code is scanned, the device that scanned and decoded this code will be directed to access this website. In some embodiments, the same device (e.g., a smartphone) is operable to scan the code, decode the dataset encoded in the code (e.g., containing a website URL), and display a website (e.g., using a web-browser) corresponding to this URL. When a text encoding code is scanned, the device that scanned and decoded this code will display the text, e.g., using a client application provided on the device. When a profile encoding code is scanned, the device that scanned and decoded this code may display the contact information and, in some embodiments, store this contact information on the device (or at a web account associated with the device).

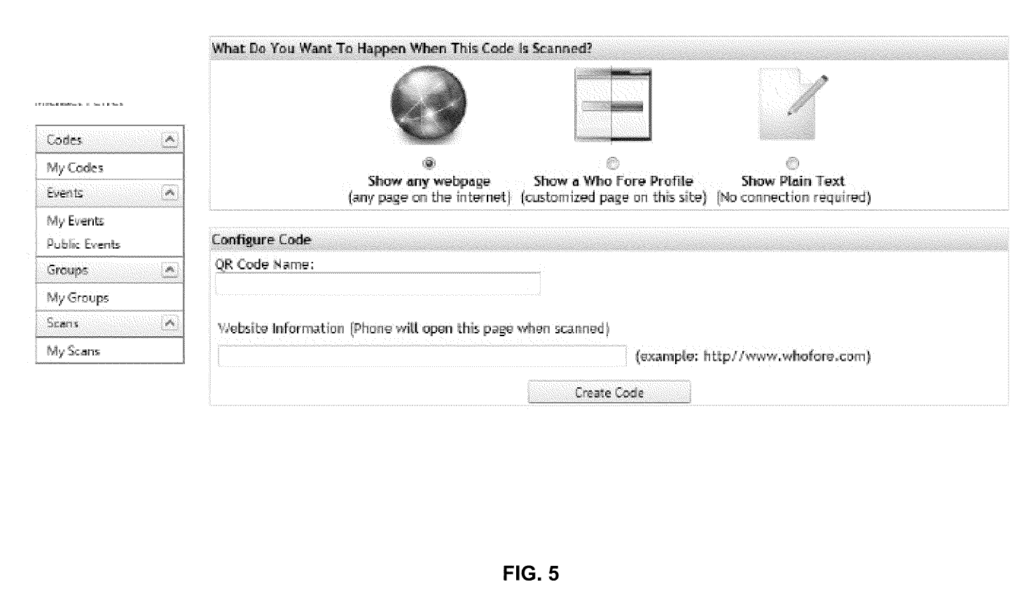

FIG. 5 illustrates an interface for providing website information to be associated with a QR code. A user presented with an option of showing any webpage, show a user profile available from the service provider (shown as “Show a Who Fore Profile”), or show plain text. If the user chooses to show a webpage, then the code configuration frame corresponding to this option appears below. This frame may allow a user to provide a human readable code name that will be visible in the code list shown in FIG. 4. Also, the frame provides a field for entering a webpage URL. Once this information is provided, the user may proceed with creating a code. At this point, the user may be returned back to the interface depicted in FIG. 4, which will show a new code and code name. This interface may be used to simulate the scan associated with each of the listed codes. For the website codes, this will open a browser displaying the website associated with this code. Furthermore, the user can go back and change the options associated with the code, e.g., delete the code, change the code type (e.g., website type, text types, and profile type), change the information associated with the code (e.g., change the website URL, change the text), and perform other functions.

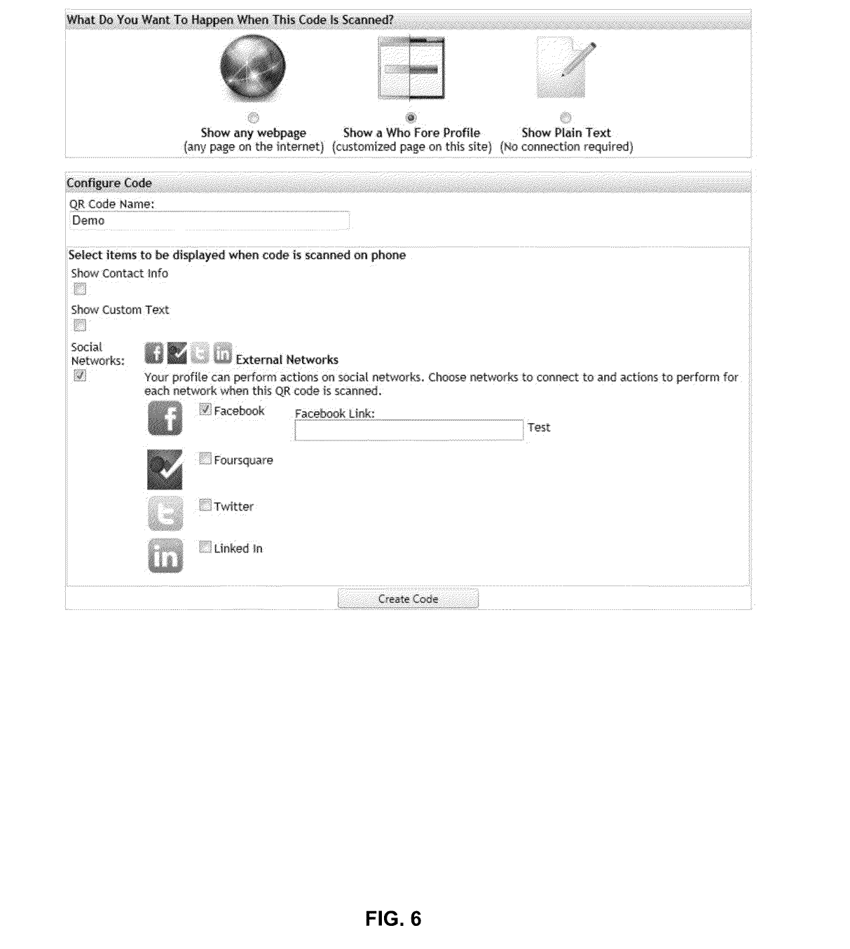

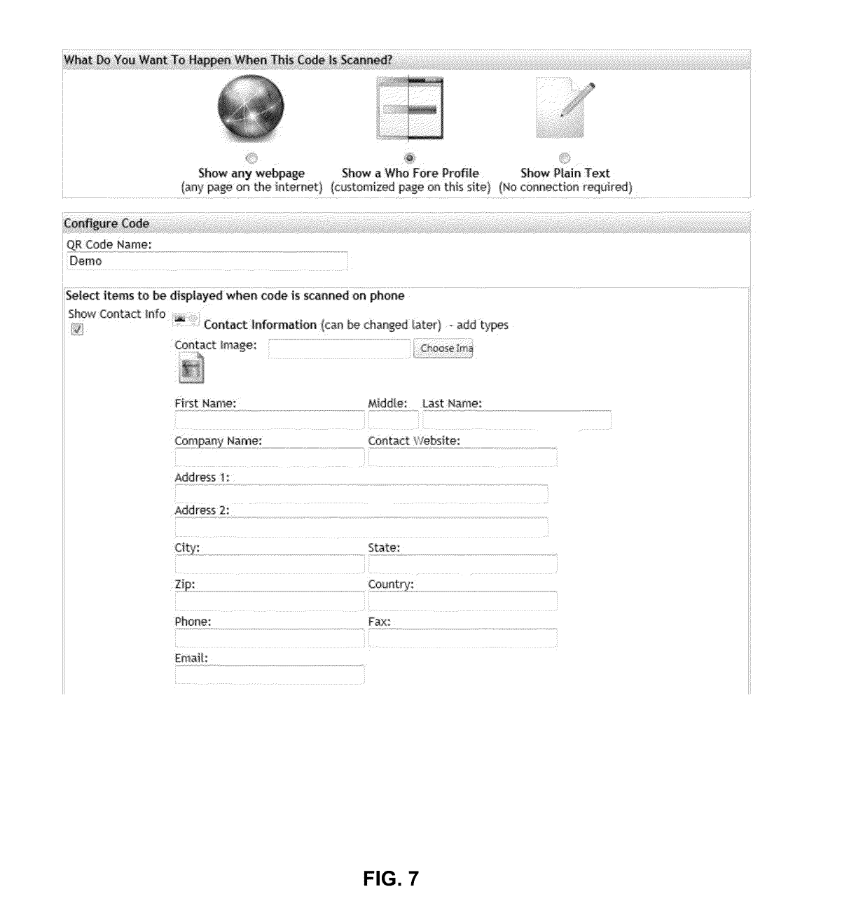

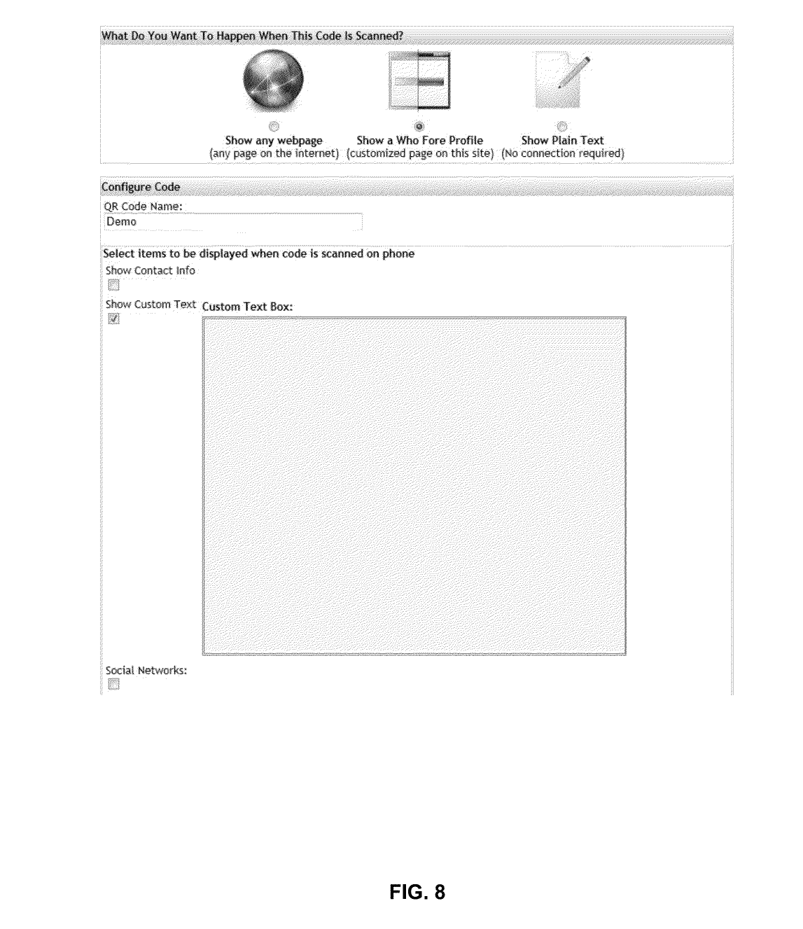

FIGS. 6-8 illustrate interfaces for providing profile information to be associated with a QR code. Specifically, these interfaces allow a user to specify the code name that will be used for identification and visible in the common interface depicted in FIG. 4. The profile information interfaces also allow the user to choose showing contact information, custom text, and social network profiles associated with the user. Specifically, FIG. 6 shows a checkbox for the social network option selected and four social network options: Facebook, Foursquare, Twitter, and Linked In. The user can enter profiles for one or more of these networks for sharing when the QR code is scanned. Additionally, other social network profiles may also be shared. FIG. 7 illustrates a frame when the displaying contact information option is selected. The user can upload a picture (which will be downloaded when the QR code is scanned), name, address, phone, e-mail and other types of contact information and profile related information in this frame. FIG. 8 illustrates a frame when showing a custom text option is selected. The user can enter text which will be downloaded when the QR code is scanned. In some embodiments, this text may be encoded into the QR code, and no separate download may be needed.

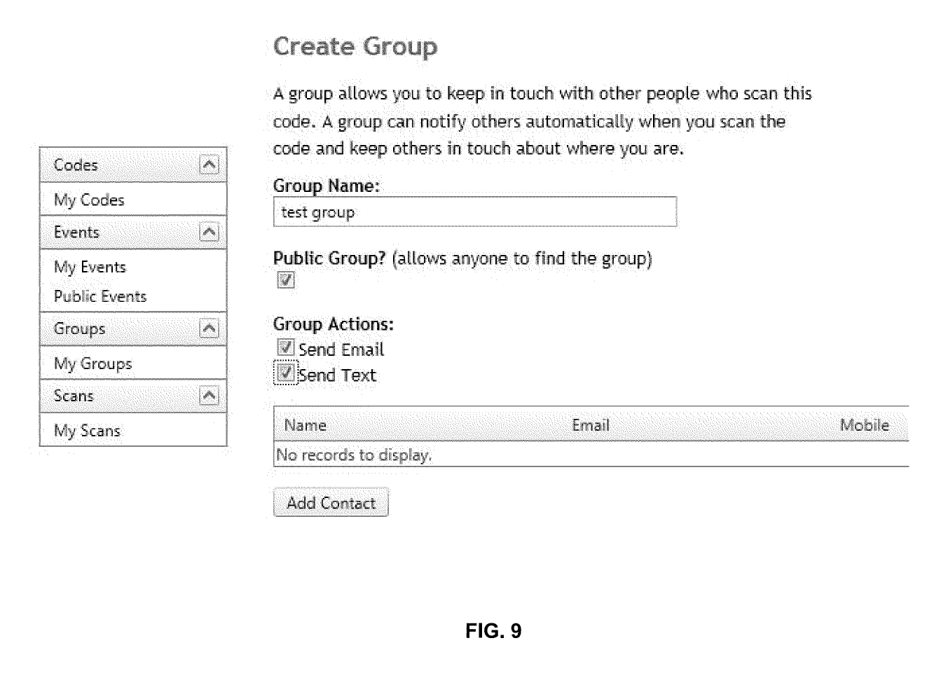

FIG. 9 is an interface of the application management console that allows creating a group of users. Organizing users into a group makes it easier to create and manage social events involving multiple people. For example, QR codes may be distributed for all people (i.e., members) listed in the group. In the same or another embodiment, all people in the group may be updated if one of the members scanned the code or provided his code for scanning. This feature may be used, for example, to notify the entire group when one of the members arrived to the event (evidenced by the code scan).

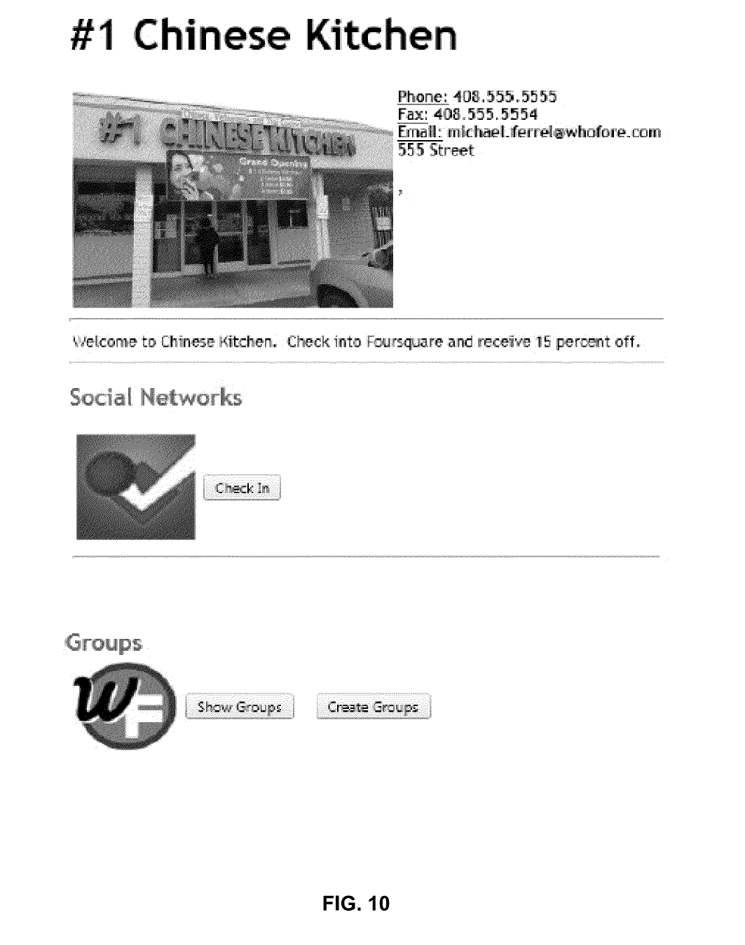

FIG. 10 is an interface of the application management console that shows a result of a scanned QR code. Specifically, it shows information associated with the location venue, including a photo, address, contact information, and discount information. This event may be created by the venue owner (e.g., a restaurant owner in this example) to promote its venue, for example, on a social network. The venue owner may also control which information is given about the venue, offer promotions, allow check-ins, and allow groups to be created.

When a user scans a QR code associated with an establishment, along with viewing information about the establishment, the user may also have the option of viewing groups associated with that establishment or creating a new group. For example, a user may view existing groups associated with the establishment and request to join an existing group. Alternatively, a user may create a new group associated with the establishment and add contacts to the group. Each subsequent time a group member scans the QR code for the establishment, all contacts or users in the group associated with the establishment may automatically receive an email, text message, other communication or alert.

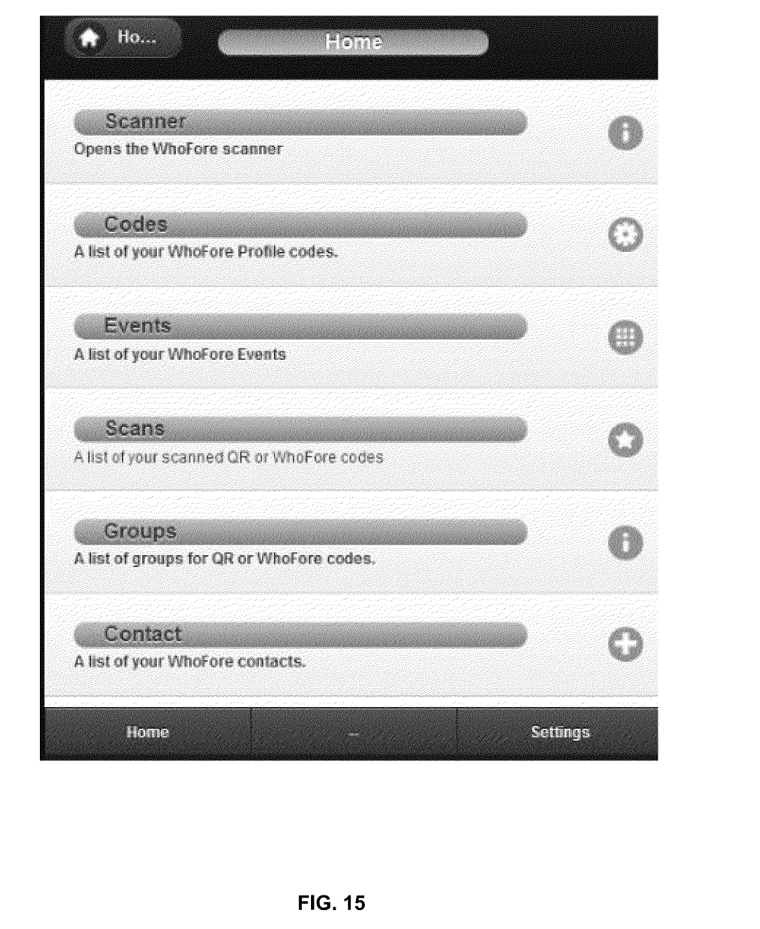

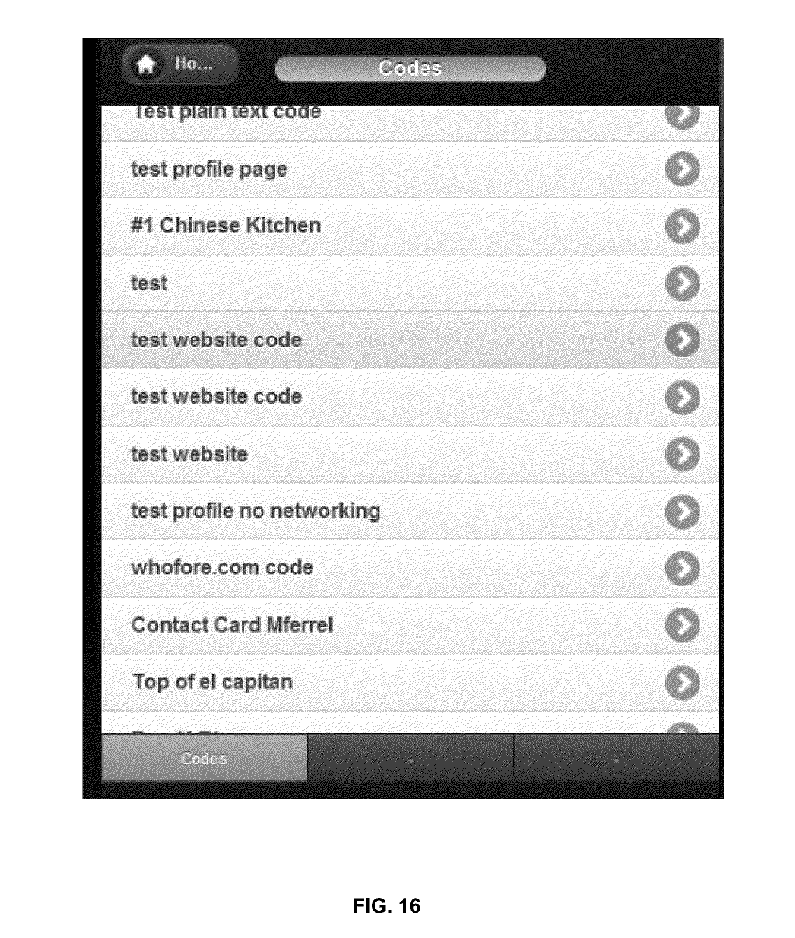

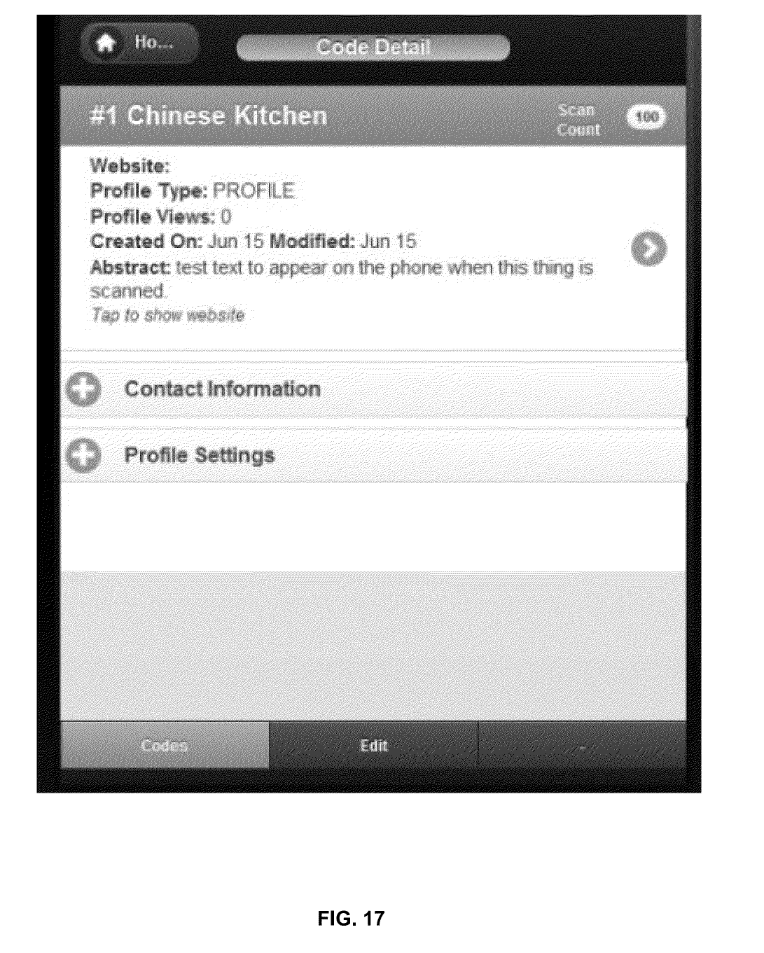

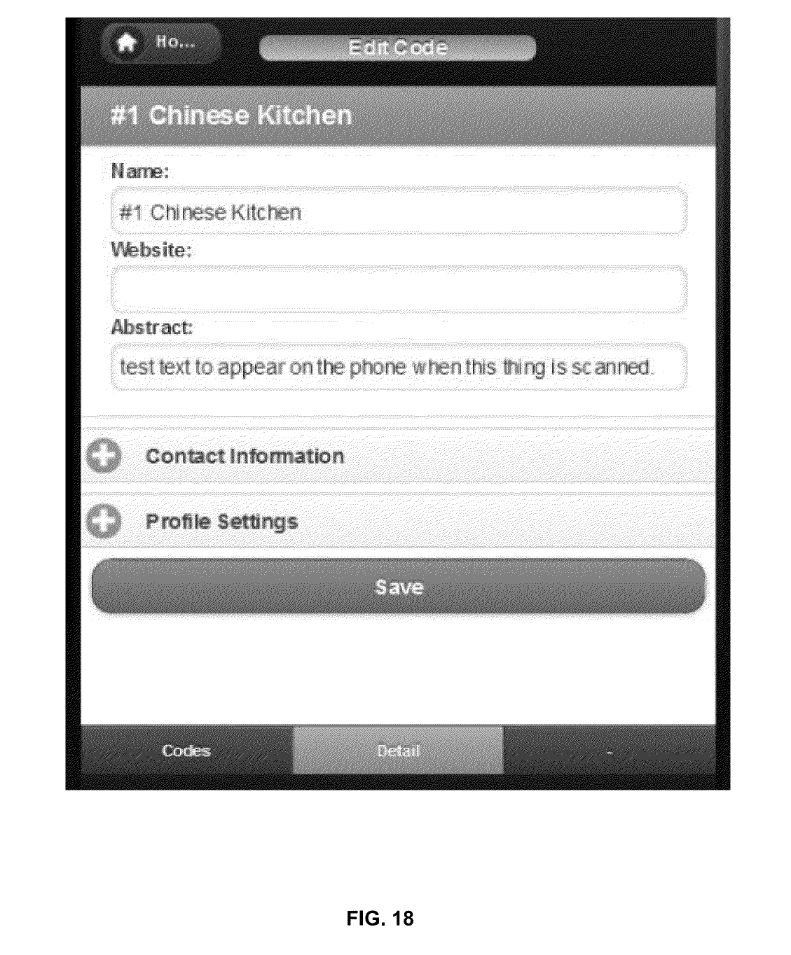

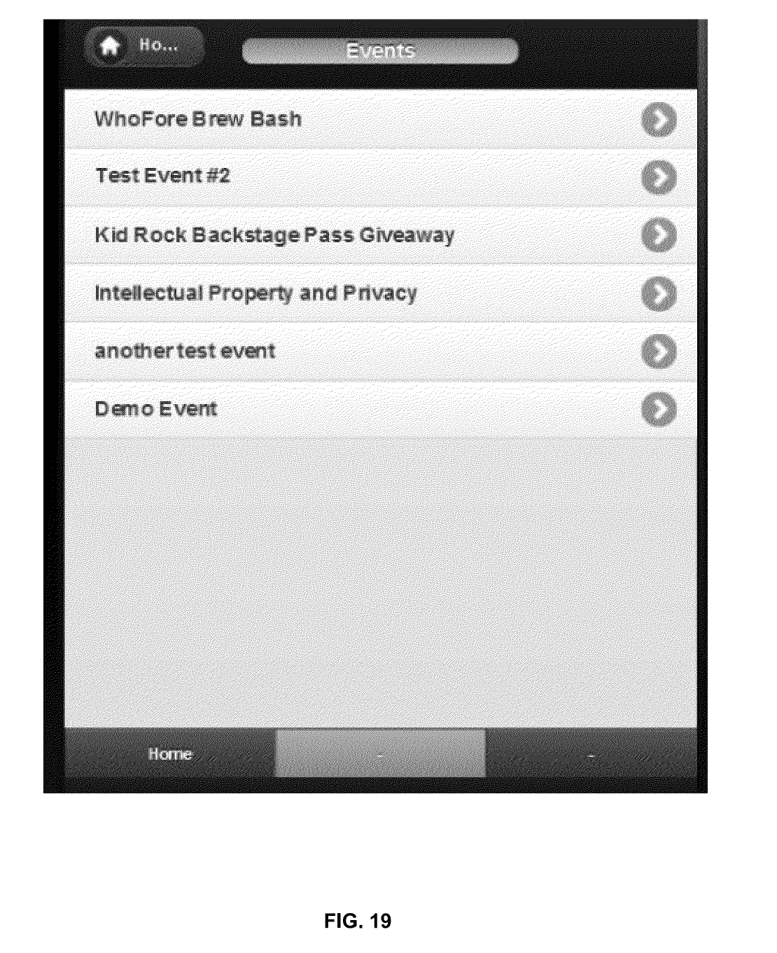

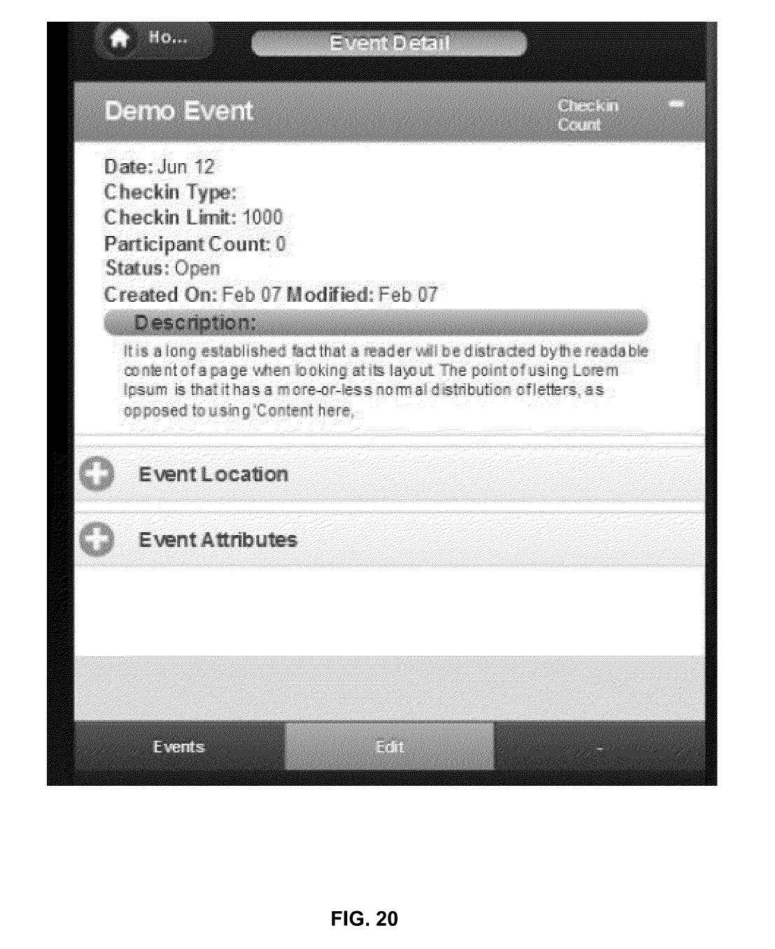

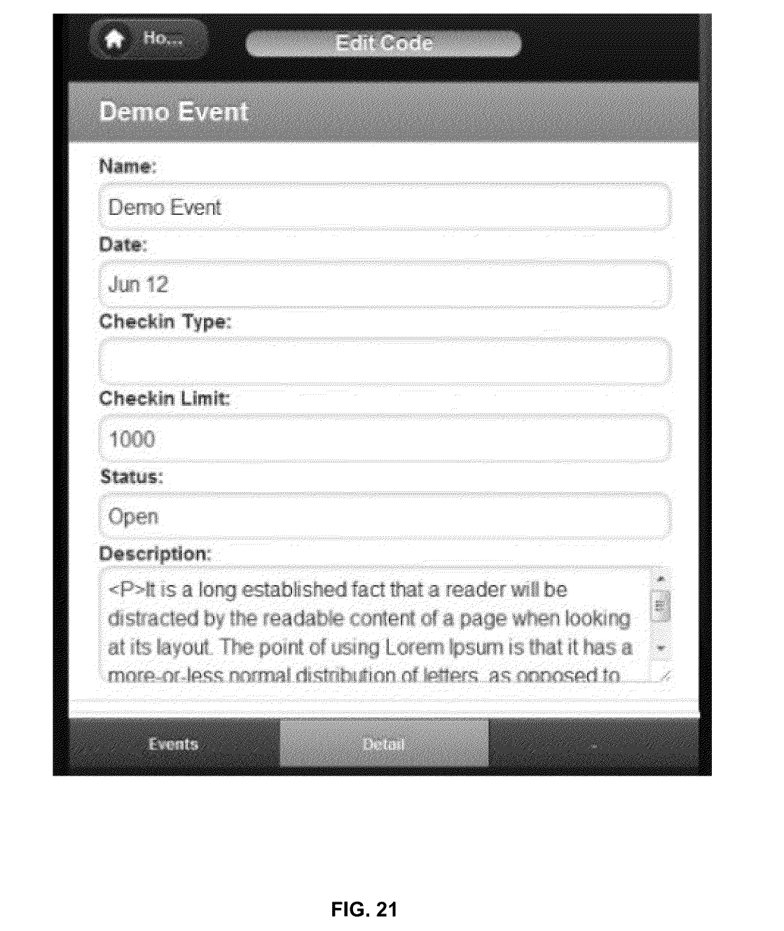

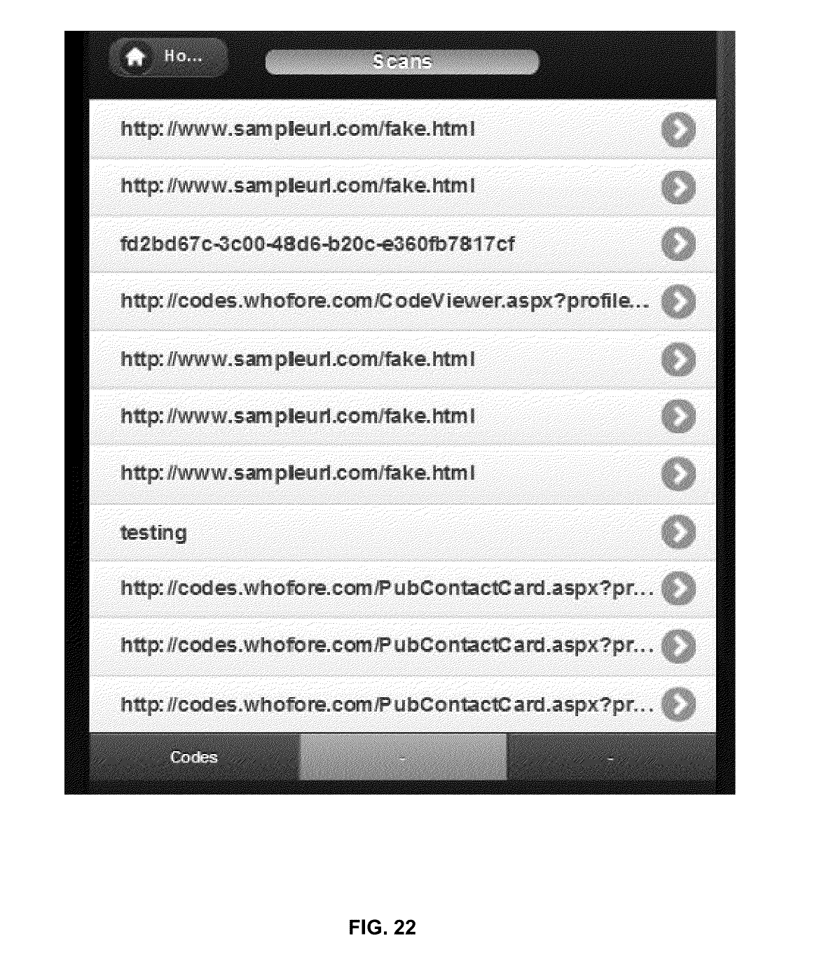

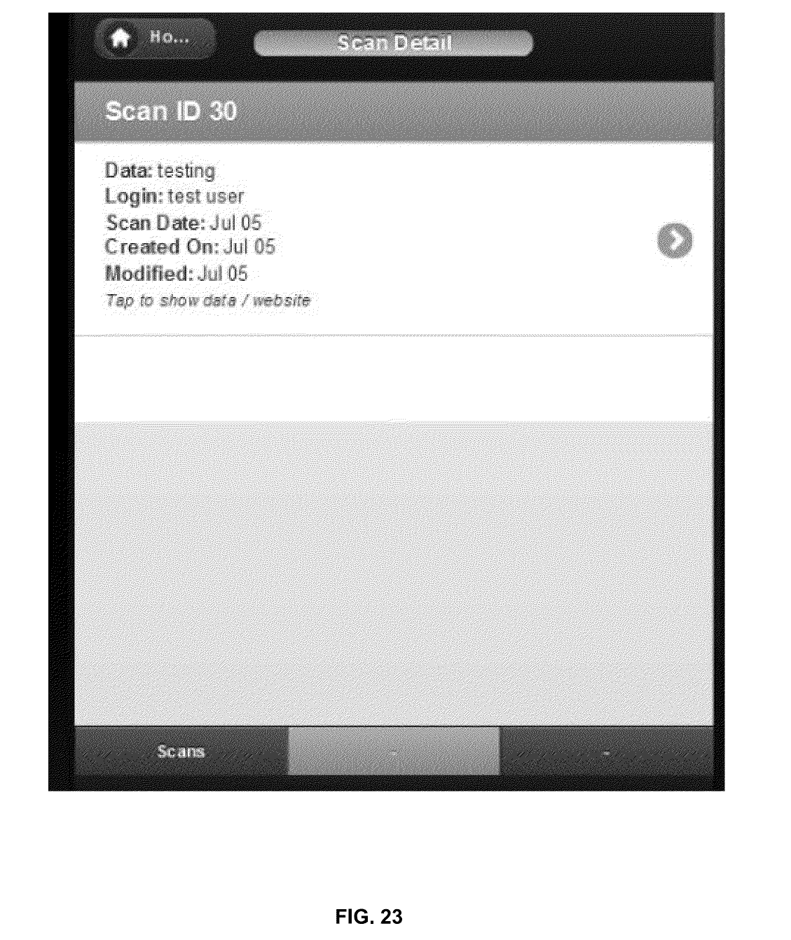

FIGS. 15-23 illustrate various examples of user interfaces provided by the client application, in accordance with some embodiments. Some of these user interfaces may correspond to user interfaces provided by the application management console described above. In other words, the client application may be used in a manner similar to the application management console in some embodiments.

Returning to FIG. 2, the method 200 may proceed with receiving the information associated with an event during operation 204. This information may be provided using one or more interfaces described above. For example, a user may set up a group by providing members' names and contact information. The user may also set up a venue by providing venue name, venue location, venue and/or event description, event time, directions, and other related information. In some embodiments, the service provider may develop a specific webpage associated with the group, member, event, QR code, or other entity that may be accessed either through the application management console, client application, or simply providing a corresponding URL into a web browser. This website development operation is reflected by block 205. In some embodiments, this URL may be encoded in a QR code.

The method 200 may proceed with generating one or more QR codes during operation 206. The QR code(s) may correspond to the information associated with an event and may encode a specific dataset. This operation may be triggered by a user selecting a specific field in the application management console as, for example, shown in FIGS. 5 and 6.

The method 200 may proceed with transmitting the QR code or the dataset encoded by the QR code to one or more users during operation 208. These users may be registered users of the service provider or some external users. For example, a registered user may provide contact information of one or more people through an interface of the application management console (e.g., the group creation interface shown in FIG. 9). If the receiving users have a client application on the devices that is capable of generating QR codes, then operation 208 may involve transmitting datasets to be encoded into QR codes. In other examples, when users do not have such a client application, then actual QR codes may be transmitted. The QR codes may be transmitted as image files, e.g., TIFF files, JPEG files, PDF files, and the like.

In some embodiments, the method 200 may involve transmitting a client application for decoding and/or encoding the QR code as shown by block 209a. For example, a user may receive a QR code that needs to be decoded but his or her device does not have an application to perform this function. The QR code may come with instructions directing the client device to the website for downloading the client application. Furthermore, a client device may receive a dataset that needs to be encoded into a QR code for presenting to other devices. If the client device does not have the client application to perform this function, then the client device may proceed with requesting this application form the service provider. The server provider may then transmit the application to the client device.

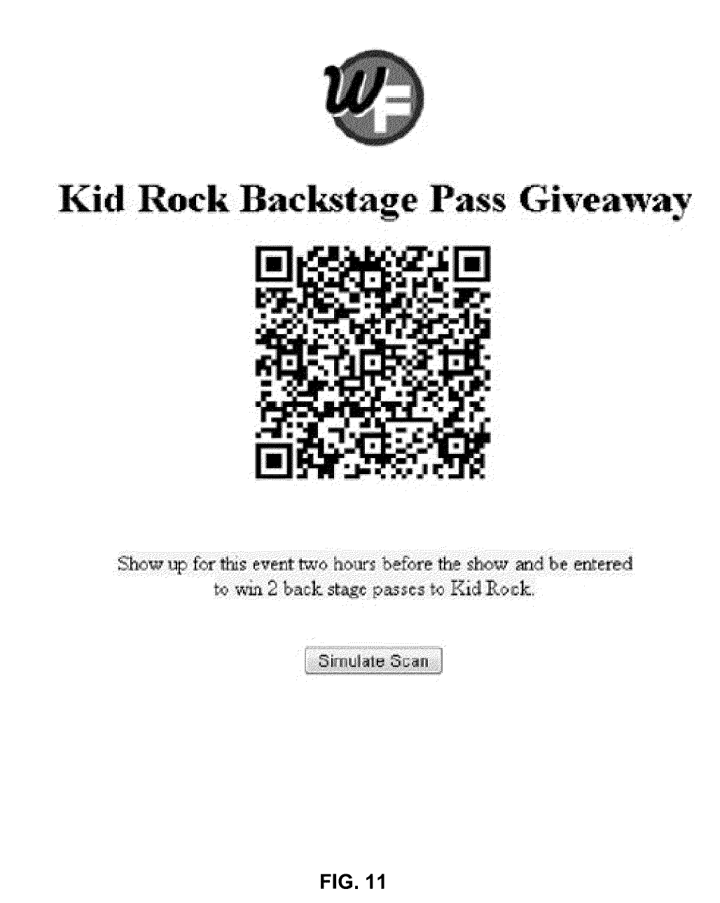

In some embodiments, the QR code is transmitted together with code descriptor information as shown by block 209(b) in FIG. 2. For example, the QR code may encode an access key that may generally not be understood by a human. The code descriptor information provided together with the QR code may explain to the user the purpose, function, and/or other attributes of the QR code. FIG. 11 illustrates an example of a QR code displayed together with the descriptor information. As shown, the descriptor information may include text, logos, and other types.

The method 200 may proceed with receiving a dataset encoded by a QR code during operation 210. This dataset may be the same dataset used to generate a QR code in operation. For example, a QR code may be generated and transmitted to one user. This user may display this code on his or her client device, and the code is scanned by another user using another device. This other device may decode the dataset provided in the QR code and transmit this information back to the service provider. The service provider may interpret this receipt as indication that the first and second user actually met due to the scan of the QR code. This feature may be used to count the number of users at a venue, establish connections among the users, and provide additional information to users who transmitted the dataset. For example, the dataset may include a website URL that may be accessed by users who received and decoded the QR code.

The method 200 may proceed with updating information associated with the event during operation 212. This may include information available in the database of the social media platform. The information may be updated based on datasets received from different client devices during operation 210. For example, the social media platform may track how many people checked in to a venue by scanning a QR code associated with the venue or presented their QR codes for scanning. Information may be also updated through the application management console.

The method 200 may proceed with transmitting the updated information to users during operation 214. For example, an event may be associated with a group of users, who are interested to know who accepted invitation to the event and actually showed up. For example, when a user scans his or her QR code at the venue, the information associated with this event may be updated to reflect that the user is actually now at the venue. Other members of the group may receive a notification indicating that this person is at the venue. At the same time, the person who scanned the QR code may be provided with the information indicating all people currently present at the venue. In some embodiments, this transmission of the updated information is associated with generation and transmission of new QR codes as reflected by operation 216.

Users may register with a website associated with the social media platform and generate one or more QR codes for various uses described above. The social media platform may maintain the created QR codes within the database so that the users can use various tools to plan events, search for the QR codes in the database, communicate with other users, download the client application 162, and integrate with social networks such as, for example, Facebook, Foursquare, LinkedIn, Twitter, and Google+.

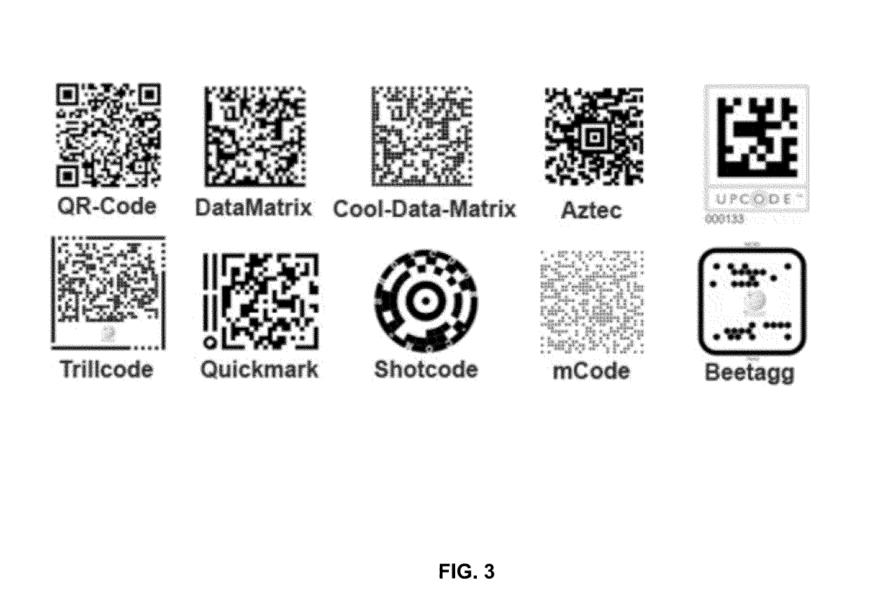

FIG. 3 is a block diagram of example QR codes which can be accessed by an automated sensing device and capable of being decoded into a text or other data. Various different types of two-dimensional barcodes exist that may be used as described above. Some examples include QR code, data matrix, cool data matrix, Aztec, upcode, trillcode, quickmark, shotcode, mcode, and beetagg.

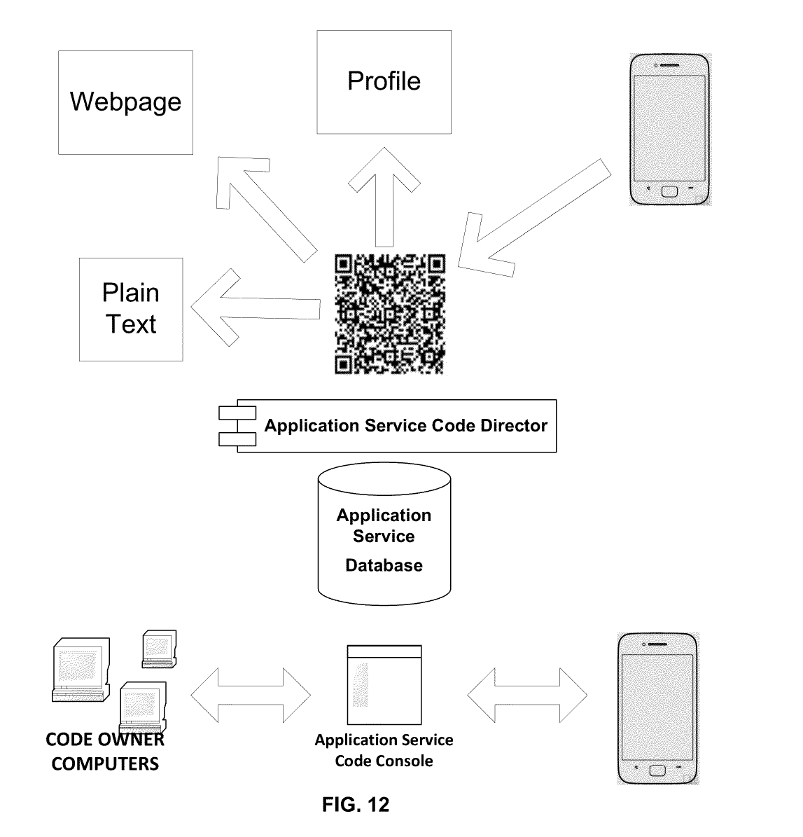

FIG. 12 is a core functionality diagram, according to an example embodiment. A user can create a profile, upload his/her pictures, and provide a link to his/her social network profile or location-based social network. The QR code may be directed such that, in response to the QR code being scanned, the profile information may appear as well as the pictures uploaded by the user. In addition, a person reading the social network profile information may click “like” on the Facebook page and check in on Foursquare. For example, if the user walks into a bar, his/her QR code can be scanned at the door and his/her information may be made available to other people in the bar. The user may also simultaneously be checked in to the bar via Foursquare, or “like” the Facebook page of the bar.

The QR code may be printed with code words embedded inside of the QR code, or with an embedded URL. When the QR code is scanned with any of the different type of scanners, a user can be redirected to that URL. Based on the URL, the code director may check settings associated with the QR code. Based on the settings, a profile may be displayed or the user may be redirected to a website. The number of times the QR code was scanned may be calculated. The application management console 118 may allow logging in and controlling what a specific QR code does. The initial setting can be modified, for example, each time the QR code is accessed, instead of the user being redirected to a website, the user may see a certain image. The user associated with the QR code may keep modifying the settings to perform different actions when the QR code is scanned.

Once a QR code is scanned, the data associated with the QR code is stored in a database. The scanning party may store the people associated with scanned QR codes as contacts (personal or business) and send them various alerts. An event can be created and one or more contacts invited to the event. For those scanned contacts who are not users of the social medial platform and/or have QR codes originated by other providers, the QR codes can still be scanned, organized, and stored to the database. For example, a QR code associated with a movie may be scanned and information related to the movie may be shown such as a description of the movie, movie theaters where the movie is playing, playing time of the movie, principal actors, and other information.

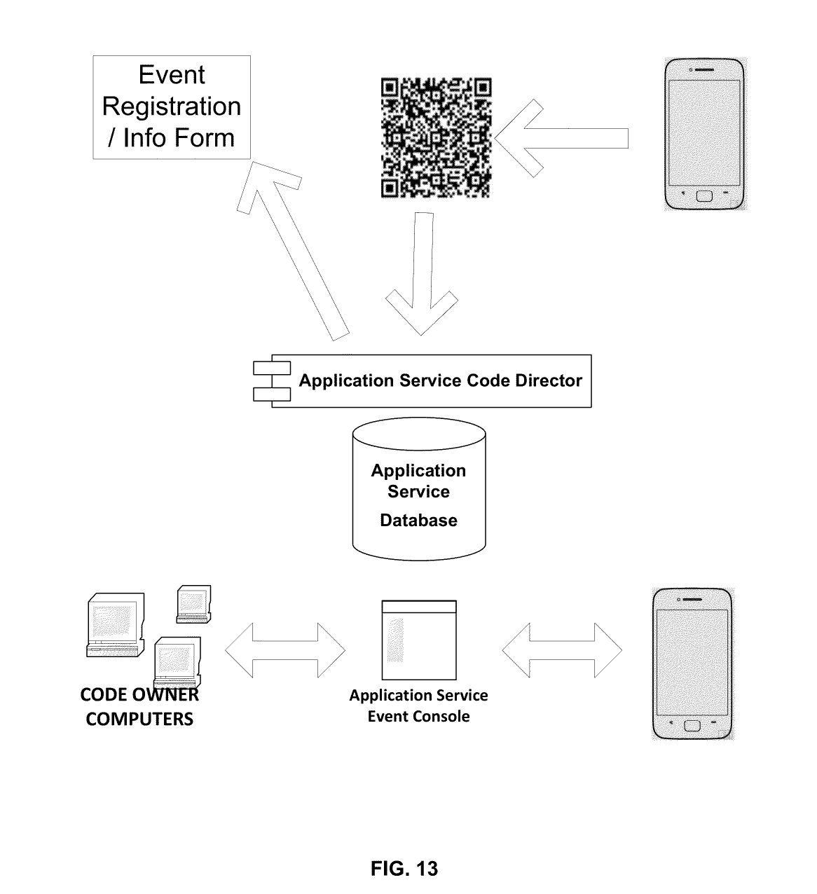

FIG. 13 is an event functionality diagram, according to an example embodiment. In case of an event, various events related functionalities can be utilized. As used herein, an event may include, but is not limited to, any gathering that may be setup/organized for more than one person/invitee. For example, a QR code may be created for checking in and out of an event. For example, the first 100 people to show up and scan their QR codes may be presented a form for an event which asks for further information, such as an email. The information provided by the first 100 people may be stored to the database. This way, nobody needs to be paid to check people at the door, as people may scan their codes and provide required information. Once the first 100 people are checked in, the event may be closed, for example. Upon checking in, other attendees may be alerted so that every person in the event knows when somebody checks in. People who check in do not have to be registered with the service. However, if they are registered, the service may not ask them to fill out the form, instead the information may be provided automatically based on their stored profile. On the other hand, if the attendee is not registered with the service, he/she may be asked to enter information.

At the event, various games and raffles can be operated based on the information provided by the event attendees. For example, $250 may be given to a random person selected from the event attendees. Some embodiments may be used to check employees in at work. Employees may check in at work and their information may be directed to a website so it is easy to determine who is in the office. Thus, every time a QR code is scanned, the application may read the QR code, encode it as a string and send the string to the service and the service may look up the setting associated with the QR code and redirect the user according to the settings.

If a user is associated with a business (e.g., a restaurant), the user may opt to redirect to a menu with a possibility of “liking” the menu on Facebook, thereby getting extra marketing for free.

Different types of events can be provided. Based on the type of event, various forms can be created for attendees to fill. An attendee may scan the code, enter their name and email. This functionality can be provided for multiple logins using a device such as, but not limited to, an iPad or the like. If an attendee is pre-registered, he/she may be able to enter by just scanning their QR code. As the event progresses, the event can be altered, the text that appears on the device changed, and a new description provided. Other information such as the location and the limit as to how many people are allowed into the event may be changed dynamically.

All connections (previously scanned users) can be listed along with their information. Checkboxes can be provided to select, for example, 5 people out of the connections, and invite them to another event or create a new event, specifically for these connections.

Various embodiments may be used, for example, to target fraternities, sororities, sports clubs, or any other organization. Other uses may include a bicycle meeting, to determine, for example, who checked in at a 20 mile marker, at a 40 mile marker, and so forth.

The technology can be used to organize private and public events, where the only way to get to a private event is to get an invitation with a QR code.

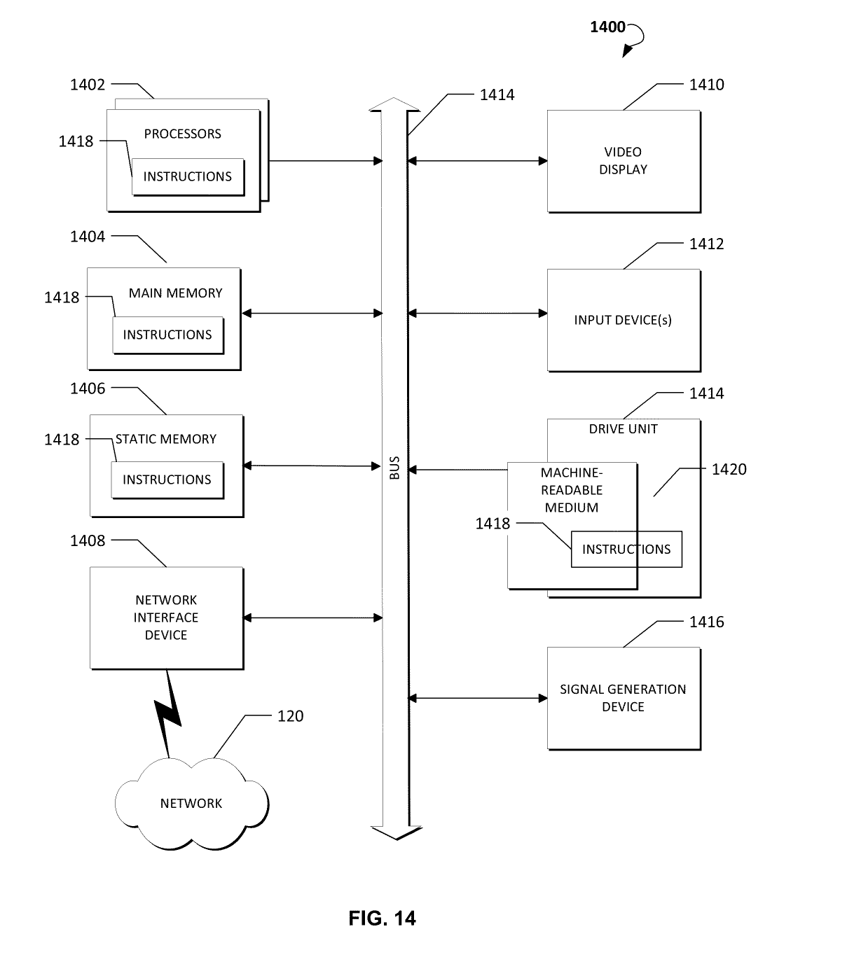

FIG. 14 shows a diagrammatic representation of a computing device for a machine in the example electronic form of a computer system 1400, within which a set of instructions for causing the machine to perform one or more of the methodologies discussed herein. In example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor or multiple processors 1402 (e.g., a central processing unit (CPU), a graphics processing unit (GPU), or both), and a main memory 1404 and a static memory 1406, which communicate with each other via a bus 1408. The computer system 1400 can further include a video display unit 1410 (e.g., a liquid crystal display (LCD) or cathode ray tube (CRT)). The computer system 1400 also includes at least one input device 1412, such as an alphanumeric input device (e.g., a keyboard), a cursor control device (e.g., a mouse), a microphone, a digital camera, a video camera, and so forth. The computer system 1400 also includes a disk drive unit 1414, a signal generation device 1416 (e.g., a speaker), and a network interface device 1418.

The disk drive unit 1414 includes a computer-readable medium 1420 which stores one or more sets of instructions and data structures (e.g., instructions 1414) embodying or utilized by any one or more of the methodologies or functions described herein. The instructions 1414 can also reside, completely or at least partially, within the main memory 1404 and/or within the processors 1402 during execution thereof by the computer system 1400. The main memory 1404 and the processors 1402 also constitute machine-readable media.

The instructions 1414 can further be transmitted or received over the network 120 via the network interface device 1418 utilizing any one of a number of well-known transfer protocols (e.g., Hyper Text Transfer Protocol (HTTP), CAN, Serial, and Modbus).

While the computer-readable medium 1420 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for social media using QR codes have been described. The disclosed technique provides a useful tool to enable people to easily aggregate and share digital content such as photos, videos, and the like associated with social events via a network. The aggregation may be performed from different sources in association with the same social event. The content may also be subjected to an image recognition process to define one or more individuals appearing on the photos/videos. Shared content may also be filtered to sort only those photos or videos in which certain participants appear. In addition, users may set privacy rules to hide those parts of photos or video in which they appear.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for facilitating social interaction using social media, the method comprising:
providing an application management console for collecting information associated with an event;
receiving the information associated with the event;
generating a Quick Response (QR) code corresponding to the information associated with the event, wherein the QR code encodes a dataset; and
transmitting the QR code or the dataset encoded by the QR code.

2. The method of claim 1, further comprising receiving the dataset encoded by the QR code from a client device and transmitting at least some of the information associated with the event to the client device.

3. The method of claim 2, wherein the information transmitted to the client device in response to receiving the data set comprises one or more of a webpage URL, a contact profile, or a text.

4. The method of claim 3, wherein the contact profile comprises one or more of a contact photo, a contact name, a contact address, a contact phone number, a contact e-mail address, or a text.

5. The method of claim 3, wherein the webpage URL comprises one or more social website URLs.

6. The method of claim 1, further comprising receiving the dataset encoded by the QR code and an additional dataset and updating the information associated with the event based on the additional dataset.

7. The method of claim 6, wherein the additional dataset comprises identification information associated with a user transmitting the dataset.

8. The method of claim 6, further comprising transmitting the updated information associated with the event to one or more client devices identified in the updated information.

9. The method of claim 8, further comprising generating a new QR code corresponding to the updated information associated with the event, wherein the new QR code encodes a new dataset; and
transmitting the new QR code or the new dataset encoded by the new QR code to one or more client devices identified in the updated information.

10. The method of claim 1, further comprising transmitting an application to a client device for decoding the QR code.

11. The method of claim 1, wherein the information associated with the event comprises one or more of a contact list, venue information, or update rules.

12. The method of claim 1, further comprising generating multiple QR codes, each code associated with an individual contact identified in the information associated with the event, and transmitting each of the multiple QR codes to a respective one of the individual contacts.

13. The method of claim 1, wherein the QR code is transmitted as an image file for displaying on a graphical interface of a client device.

14. The method of claim 1, wherein the dataset comprises a webpage URL.

15. The method of claim 14, further comprising developing a webpage corresponding to the webpage URL, wherein the webpage is developed based on the information associated with the event.

16. The method of claim 1, wherein the dataset comprises personal contact information.

17. The method of claim 1, wherein the application management console is operable to simulate a graphical user interface of a client device after scanning the QR code.

18. The method of claim 1, further comprises transmitting descriptor information associated with the QR code.

19. A social media platform comprising:
an application management console for collecting information associated with an event;
a database for storing the information associated with the event;
a Quick Response (QR) code generator for generating a QR code corresponding to the information associated with the event; and
application engine for transmitting the QR code or a dataset encoded by the QR code and receiving the dataset.

20. A non-transitory machine readable medium having embodied thereon executable code, the executable code being executed by a processor for performing a method for facilitating social media and event planning, the method comprising:
providing an application management console for collecting information associated with an event;
receiving the information associated with the event;
generating a Quick Response (QR) code corresponding to the information associated with the event, wherein the QR code encodes a dataset; and
transmitting the QR code or the dataset encoded by the QR code.

21. A method for facilitating social interaction using social media, the method comprising:
providing an application management console for collecting information associated with an event and an associated group;
receiving the information;
generating a Quick Response (QR) code corresponding to the information, wherein the QR code encodes a dataset; and
transmitting the QR code or the dataset encoded by the QR code.

22. The method of claim 21, wherein the information comprises identification of members of the group, the method further comprising:
in response to receiving the dataset encoded by the QR code from a client device of a group member, automatically transmitting to client devices associated with other members of the group a communication including information associated with the event or group.
